(19) United States
(12) Patent Application Publication
(10) Pub. No.: US 2022/0271316 A1
(43) Pub. Date: Aug. 25, 2022

(54) RELEASE FILM FOR USE IN MANUFACTURING OF AN ELECTROLYTE MEMBRANE OR A MEMBRANE ELECTRODE ASSEMBLY

(71) Applicant: W. L. Gore & Associates G.K., Tokyo (JP)

(72) Inventors: Takeyuki Suzuki, Tokyo (JP); Taichi Hamamoto, Tokyo (JP)

(21) Appl. No.: 17/626,000

(22) PCT Filed: Jul. 11, 2019
(86) PCT No.: PCT/IB2019/055931

§ 371 Date: Jan. 10, 2022

(51) Int. Cl. H01M 8/1069; H01M 8/106; H01M 4/88; H01M 8/1004

(52) U.S. Cl. CPC H01M 8/1069; H01M 8/106; H01M 4/8846; H01M 8/1004; H01M 2008/1095

(57) ABSTRACT

The present invention relates to a laminate comprising (i) an ion exchange membrane comprising an ion exchange polymer, and (ii) a monolayered release film removably adhered to at least one side of the ion exchange membrane, wherein the monolayered release film comprises at least 95% by weight of syndiotactic polystyrene (sPS). The invention also relates to a method for producing the laminate, use of the monolayered release film in producing an electrolyte membrane or a membrane electrode assembly, and a method for producing an electrolyte membrane or a membrane electrode assembly.

### CROSS-REFERENCE TO RELATED APPLICATION

This application is a national phase application of PCT Application No. PCT/IB2019/055931, internationally filed on Jul. 11, 2019, which is herein incorporated by reference in its entirety for all purposes.

This invention relates to a laminate comprising a monolayered release film removably adhered to an electrolyte membrane, a method for producing the laminate, use of the monolayered release film in producing an electrolyte membrane or a membrane electrode assembly, and a method for producing an electrolyte membrane or a membrane electrode assembly, such as a membrane electrode assembly of a polymer electrolyte fuel cell.

### BACKGROUND

A fuel cell converts chemical energy of a fuel, such as hydrogen or methanol, into electric. energy through an electrochemical reaction of the fuel with oxygen or another oxidizing agent.

All fuel cells contain a so-called membrane electrode assembly (MEA), which comprises an ion exchange membrane (IEM) sandwiched between an anode electrode and a cathode electrode, EMs are used in fuel cells as solid electrolyte membranes. Ion exchange membranes are also used in electrolysis of sodium chloride solutions to form chlorine gas and sodium hydroxide. Additionally, IEMs are useful in flow batteries and in the areas of diffusion dialysis, water electrolysis, electrodialysis and for pervaporation and vapor permeation separations.

Fuel cells are classified primarily by the type of electrolyte. Examples of fuel cells are proton exchange membrane fuel cells (PEMFCs, also called polymer electrolyte membrane fuel cells, PEFCs), alkaline fuel cells (AFCs), phosphoric add fuel cells (PAFCs), molten carbonate fuel cells (MCFCs) and solid oxide fuel cells (SOFCs).

Polymer electrolyte fuel cells are particularly advantageous because they operate at lower temperatures than other fuel cells. Also, polymer electrolyte fuel cells do not contain any corrosive adds which are found in phosphoric acid fuel cells.

A PEMFC is produced by laminating multiple single cells where each cell comprises a membrane electrode assembly including a stack of a polymer electrolyte membrane (ion exchange membrane) and gas diffusion electrodes attached to each surface of the electrolyte membrane. Each gas diffusion electrode includes a laminate of an electrode catalyst layer (usually a platinum catalyst) and a gas diffusion layer. The gas diffusion layer (GDL) enables access of hydrogen or oxygen to the respective catalyst layer and is generally made of hydrophobized porous carbon paper/cloth, but other materials have also been suggested.

The electrolyte membrane of PEMFCs conducts protons only and electrons formed at the anode are transferred through an external circuit from the anode to the cathode thereby generating the electric energy. The electrolyte membrane of PEMFCs may comprise, for example a perfluorosulfonic add (PFSA) polymer, such as a tetrafluoroethylene/fluorovinyl-ether copolymer with sulfonic add groups (e.g. Nafion® supplied by DuPont).

In order to increase PEM conductance and overall PEMFCs power output, there has been a drive to reduce PEM thickness. The PEMs are usually very thin, such as 10 and 200 μm. Reducing PEM thickness, however, can result in reduced structural integrity and handling problems during the manufacturing process. PEMs are therefore generally reinforced by an additional reinforcement material, for example a porous reinforcement material (e.g. an expanded polytetrafluoroethylene (ePTFE) membrane) impregnated with the electrolyte material (e.g. PFSA).

For example, US 2011/020730 relates to a biaxially oriented film suitable as a reinforcing member for an electrolyte membrane of a polymer electrolyte fuel cell. The reinforcing member is part of the final PEM. The biaxially oriented film contains a syndiotactic polystyrene (sPS) and has a Young's modulus in at least one of the machine direction and the transverse direction ranging from 4,500 to 8,000 MPa.

To facilitate handling and prevent deformation and destruction, such as wrinkling or breakage, of a thin polymer electrolyte membrane during production, transfer, storage and processing thereof, the polymer electrolyte membrane is generally provided on a support film (also referred to as backing layer, release film or backer). The support film is used as a support base for forming the polymer electrolyte membrane. The support film is thereafter detached (peeled off) from the polymer electrolyte membrane prior to laminating the polymer electrolyte membrane with the electrodes in the manufacturing of the fuel cell. Thus, the support film is usually not present in the final fuel cell.

A releasable support film needs to have sufficient mechanical strength to endure continuous web handling and adequate release properties (releasability) allowing the support film to be easily peeled off from the membrane. However, there must still be enough adhesion to resist unintentional separation of the support film from the membrane. The support film should not contaminate the electrolyte membrane and should possess heat resistance (at temperatures of, for example, 130-190° C.), chemical resistance (e.g. acid resistance), anti-staining properties and dimensional stability.

EP 2422975 discloses a laminate comprising a release film made of a cycloolefinic copolymer (COC) and a layer containing an ion exchange resin laminated on the release film. The laminate further comprises a base film, such as a film made of polyethylene terephthalate (PET), polyethylene naphthalate (PEN) or polypropylene (PP), laminated on the side of the release film opposite to the layer containing an ion exchange resin.

JP 2014175116 A relates to a support film including a base layer formed from a synthetic resin having an elastic modulus of 100-1000 MPa at 150° C. (e.g. polyester) and a release layer of a syndiotactic polystyrene (sPS) resin coated on at least one side of the base layer.

JP 2016096108 A relates to an electrolyte membrane structure comprising an electrolyte membrane provided on a support substrate film of syndiotactic polystyrene (sPS) with “high adhesion power” on the side facing the electrolyte membrane structure compared to the back of the support film. The increased adhesion properties of the sPS sheet are disclosed to be provided by applying a fluoro-resin coat on the sPS. JP 2016096108 A refers to the resin-coated sPS as a cheaper alternative than polytetrafluoroethylene (PTFE) and tetrafluoroethylene-perfluoroalkylvinylether copolymer (PFA). Moreover, it is discussed in JP 2016096108 A that winding a laminate of an electrolyte membrane and a film of PTFE or PFA on a roll, may cause the electrolyte membrane to detach from support film due to the adhesion between the back surface of the film and the electrolyte membrane.

JP 2017081011 A relates to a laminated film for use in the manufacturing of a membrane electrode assembly. The laminated film comprises a base layer (e.g. polyester, PET, or syndiotactic polystyrene (SPS) resin), a first layer containing an adhesive component (e.g. a chlorine-containing resin) applied on at least one surface of the base layer, and a second layer containing a releasing component (e.g. a cyclic olefin resin) laminated on the first layer.

US 2017/077540 describes a support film provided by introducing fluorine atoms to at least one surface of a base film that is formed from one or more types of polymers selected from the group consisting of polyethylene, polypropylene, polyethylene terephthalate, polybutylene terephthalate, polyethylene napthalate, polyphenylene sulphide, polysulfones, polyether ketone, polyether ether ketone, polyimides, polyetherimide, polyamides, polyamide-imides, polybenzimidazoles, polycarbonates, polyarylates, and polyvinyl chloride. For example, fluorine atoms may be introduced by bringing the base film into contact with fluorine gas.

Using an adhesive resin or in other ways modifying the surface of the support film on the side of the support film facing the electrolyte membrane may contaminate the electrolyte membrane leading to, for example, deterioration of its proton conductivity. Also, the release properties of the film may change over time due to chemical migration from the support film to the electrolyte membrane. Also, using an adhesive resin or in other ways modifying the surface of the support film incurs additional costs in manufacturing of the support film. Moreover, the support film may encounter problems with non-uniform peel strength and/or non-uniform thickness.

A laminated support film is costly to produce. Furthermore, due to adhesion between the back side of the base layer (e.g. PET) and the polymer electrolyte membrane, there may be problems with delamination of the support film or unintentional release (delamination) of the electrolyte membrane from the support film when unwinding a roll of a polymer electrolyte membrane having the laminated support film adhered thereto. Also, wrinkles and curls may be formed resulting from different thermal properties of the layers of the support film. Moreover, multi-layered (e.g. dual-layered) laminates generally have a thickness of about 50 μm or more.

Thus, there is a need for a low-cost support film meeting the above discussed requirements, such as having adequate release and adhesion properties, while avoiding deterioration of the electrolyte membrane when the support film is laminated thereto.

### BRIEF SUMMARY OF THE DISCLOSURE

It has been found that a monolayered film comprising at least 95% by weight of syndiotactic polystyrene (sPS) has the required mechanical strength, chemical resistance and heat resistance, as well as suitable release and adhesion characteristics to be advantageous for use as releasable support film, hereinafter referred to as release film, in producing an electrolyte membrane or a membrane electrode assembly. The electrolyte membrane or the membrane electrode assembly may be used in manufacturing electrochemical devices, such as polymer electrolyte fuel cells, flow batteries and multi-layered diaphragms for electrolysis.

A further advantage of a monolayered release film comprising at least 95% by weight of syndiotactic polystyrene (sPS) is that it may have a thickness of less than 50 μm, for example within the range of from 25 to 40 μm, and still provide sufficient mechanical strength. This means that when a laminate of a polymer electrolyte membrane and the monolayered release film made of sPS is winded on a roll, the weight and diameter of the roll are less than for a roll of a laminate comprising a thicker laminated support film and the roll will thus be easier to handle during transfer, storage and use in the manufacturing of a membrane electrode assembly of a polymer electrolyte fuel cell.

Moreover, monolayered films of syndiotactic polystyrene are less complicated and inexpensive to produce, thereby leading to decreased manufacturing costs of membrane electrode assemblies compared to using multi-layered support films.

Thus, in accordance with a first aspect of the invention there is provided a laminate comprising an ion exchange membrane and a monolayered release film removably adhered to at least one side of the ion exchange membrane, wherein the monolayered release film comprises at least 95% by weight of syndiotactic polystyrene (sPS). The ion exchange membrane comprises an ion exchange polymer, such as a fluoropolymer comprising pendant sulfonic acid groups.

In an embodiment of the laminate, the ion exchange membrane is an electrolyte membrane, particularly a polymer electrolyte membrane.

In a further embodiment of the laminate, the ion exchange membrane is a reinforced electrolyte membrane, particularly a reinforced polymer electrolyte membrane.

By “syndiotactic polystyrene (sPS)” is meant an ordered polystyrene with the phenyl groups positioned on alternating sides of the hydrocarbon backbone. The syndiotactic polystyrene may comprise unsubstituted styrene units or ring-substituted styrene units. Syndiotactic polystyrene made from unsubstituted styrene units is produced under the trade name XAREC by Idemitsu Corporation, Japan.

The syndiotactic polystyrene of the monolayered release film of the herein disclosed laminate may be an unsubstituted syndiotactic polystyrene or a ring-substituted syndiotactic polystyrene.

Examples of ring-substituted syndiotactic polystyrenes are syndiotactic poly(alkylstyrene), syndiotactic poly(halogenated styrene), syndiotactic poly(alkoxystyrene), syndiotactic poly(phenylstyrene), syndiotactic poly(vinylstyrene) and syndiotactic poly(vinylnaphthalene). Examples of the poly(alkylstyrene) include poly(methylstyrene), poly(ethylstyrene), poly(propylstyrene) and poly(butylstyrene), such as poly(p-methylstyrene), poly(m-methylstyrene) and poly(p-tert-butylstyrene). Examples of the poly(halogenated styrene) include poly(chlorostyrene), poly(bromostyrene) and poly(fluorostyrene). Examples of the poly(alkoxystyrene) include poly(methoxystyrene) and poly(ethoxystyrene).

The syndiotactic polystyrene of the monolayered release film of the herein disclosed laminate is preferably an unsubstituted syndiotactic polystyrene.

In embodiments, the monolayered release film comprises a biaxially oriented syndiotactic polystyrene film.

A monolayered release film comprising at least 95% by weight of biaxially oriented syndiotactic polystyrene (sPS) is transparent and colourless. This facilitates control of foreign particles and contaminants by camera inspection in the manufacturing of a membrane electrode assembly. Also, biaxially oriented films comprising at least 95% by weight of syndiotactic polystyrene (sPS) allow thin films with high tensile strength.

The syndiotactic polystyrene may be an expanded syndiotactic polystyrene, particularly a biaxially oriented, expanded syndiotactic polystyrene film.

The syndiotactic polystyrene may have a weight average molecular weight of at least 10 000 g/mol. Preferably, the weight average molecular weight of the syndiotactic polystyrene is within the range of from 50 000 to 2 000 000 g/mol, more preferably within the range of from 100 000 to 1 000 000 g/mol, and most preferably, the syndiotactic polystyrene has a weight average molecular weight of 100 000 to 300 000 g/mol. In one embodiment, the syndiotactic polystyrene has a weight average molecular weight of about 177 000 g/mol, measured as described hereinafter.

In a second aspect of the invention, there is provided a laminate comprising (i) an ion exchange membrane comprising an ion exchange polymer, and (ii) a monolayered release film removably adhered to at least one side of the ion exchange membrane, wherein the monolayered release film has a peel force equal to or less than 500 mN/cm using the herein described method for measurement, and a surface energy within the range of from 23 to 50 mJ/m² using the herein described method for measurement.

Preferably, the monolayered release film has a peel force equal to or less than 150 mN/cm using the herein described method for measurement, and a surface energy within the range of from 23 to 45 mJ/m² using the herein described method for measurement.

In order for the monolayered release film to be removably adhered to the at least one side of the ion exchange membrane without any damage or irreversible deformation occurring to the ion exchange membrane or the release film when the release film is removed, the monolayered release film preferably has a tensile modulus (Young's modulus) in at least one of the machine direction and the transverse direction within the range of from 2 000 to 5 000 MPa, preferably 2 500 to 4 000 MPa. More preferably, the monolayered release film has a tensile modulus in the machine direction of from 2 500 to 4 000 MPa and a tensile modulus in the transverse direction within the range of from 2 500 to 4 000 MPa.

In embodiments, the monolayered release film may have a tensile strength in at least one of the machine direction and the transverse direction of at least 50 MPa, preferably at least 90 MPa. More preferably, the monolayered release film has a tensile strength in the machine direction of at least 100 MPa and a tensile strength in the transverse direction of at least 100 MPa.

The monolayered release film may have an average thickness of within a range from 10 to 100 μm, such as from 10 to 50 μm. Preferably, the monolayered release film has an average thickness of less than 50 μm, such as within the range of from 25 to 45 μm or from 25 to 40 μm.

In a third aspect of the invention, there is provided a method for producing a laminate as disclosed herein. The method comprises applying, such as coating or laminating, in one or more steps the ion exchange membrane on the monolayered release film. The step(s) of applying may be carried out by a roll-to-roll processing.

In an embodiment, the method comprises: applying a solution of the ion exchange polymer in a solvent on the monolayered release film thereby providing a wet coating of ion exchange polymer on the monolayered release film; and removing the solvent by drying thereby providing the ion exchange membrane on the monolayered release film.

In another embodiment, the method comprises:

applying a solution of the ion exchange polymer in a solvent on the monolayered release film thereby providing a wet coating of ion exchange polymer on the monolayered release film;

applying a porous reinforcing material (e.g. expanded polytetrafluorethylene) onto the wet coating of ion exchange polymer;

drying to remove solvent;

applying additional solution of ion exchange polymer in said solvent onto the porous reinforcing material; and

removing the solvent by drying thereby providing the ion exchange membrane on the monolayered release film.

In a fourth aspect of the invention, there is provided the use of a monolayered film comprising at least 95% by weight of syndiotactic polystyrene (sPS) as a release film in producing an electrolyte membrane or a membrane electrode assembly, such as a membrane electrode assembly of a polymer electrolyte fuel cell.

In a fifth aspect of the invention, there is provided a method for producing electrolyte membrane or a membrane electrode assembly of a polymer electrolyte fuel cell comprising providing a laminate as disclosed herein and separating the monolayered release film from the ion exchange membrane.

### BRIEF DESCRIPTION OF THE DRAWINGS

FIG. 1 illustrates an embodiment of a laminate as disclosed herein.

FIG. 2 shows peel strength (indicative of release characteristics) and surface energy (indicative of adhesion characteristics) for various plastic films, as measured using the herein described methods.

FIG. 3 illustrates the use of a monolayered release film in the production of a reinforced electrolyte membrane.

### DETAILED DESCRIPTION

In the laminate as disclosed herein, the monolayered release film removably adhered to at least one side of the ion exchange membrane comprises at least 95% by weight of syndiotactic polystyrene (sPS).

By “removably adhered”, it is meant that in a laminate comprising a monolayered release film that is adhered to an ion exchange membrane, the monolayered release film can be removed from the ion exchange membrane without any damage or irreversible deformation occurring to the ion exchange membrane or the release film.

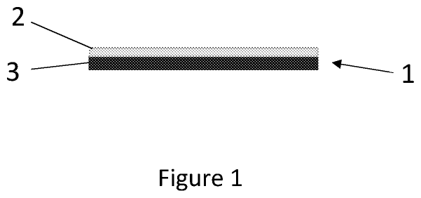

FIG. 1 illustrates an embodiment of a laminate 1 comprising an ion exchange membrane 2 and a monolayered release film 3 removably adhered to one side of the ion exchange membrane 2. The ion exchange membrane comprises an ion exchange polymer.

The monolayered release film of the laminate as disclosed herein comprises at least 95% by weight (based on the total weight of the film) of syndiotactic polystyrene (sPS) and within the range of from 0 to 5% by weight of additives, such as antioxidants, antistatic agents, agents enhancing the handleability of the film, agents modifying adhesiveness, agents improving extrusion properties, and/or agents improving conductivity.

The monolayered release film preferably consists of a chemically uniform (homogeneous) polymer composition, which means that the release film is uncoated and absent of any chemical surface modification.

The monolayered release film may have a density gradient and/or a crystallinity gradient along the thickness direction of the film. Such gradients provide a varying density and/or crystallinity of the film.

In embodiments, the monolayered release film may have an average thickness within the range of from 10 to 100 μm, such as from 10 to 50 μm, for example 12 μm, 25 μm, 35 μm or 50 μm. Preferably, the monolayered release film may have an average thickness of less than 50 μm, such as within the range of from 25 to 45 μm or from 25 to 40 μm.

In embodiments, the monolayered release film of the herein disclosed laminate may have a peel force equal to or less than 150 mN/cm (using the herein described method for measurement).

In embodiments, the monolayered release film of the herein disclosed laminate may have a surface energy within the range of from 23 to 50 mJ/m² (using the herein described method for measurement), preferably within the range of from 25 to 45 mJ/m² or 30 to 40 mJ/m² (using the herein described method for measurement)

In embodiments, the monolayered release film of the herein disclosed laminate may have a tensile modulus in at least one of the machine direction and the transverse direction within the range of from 2 000 to 5 000 MPa (preferably within the range of from 2 500 to 4 000 MPa), a tensile strength in at least one of the machine direction and the transverse direction of at least 50 MPa, a peel force equal to or less than 150 mN/cm (using the herein described method for measurement) and a surface energy within the range of from 23 to 50 mJ/m² (using the herein described method for measurement).

In embodiments, the monolayered release film of the herein disclosed laminate may have a tensile modulus in at least one of the machine direction and the transverse direction within the range of from 2 500 to 4 000 MPa, a tensile strength in at least one of the machine direction and the transverse direction of at least 100 MPa, a peel force equal to or less than 150 mN/cm (using the herein described method for measurement) and a surface energy within the range of from 25 to 45 mJ/m² (using the herein described method for measurement).

In embodiments, the laminate consists of the ion exchange membrane and the monolayered release film. Thus, the laminate according to the invention is preferably a two layer laminate.

The monolayered release film has a front side (a first planar film surface) and a back side (a second planar film surface) opposite the front side. In the laminate, the front side of the monolayered release film is removably adhered to the ion exchange membrane and the back side of the monolayered release film is preferably non-covered (i.e. non-laminated and non-coated).

The front side may have a first surface roughness and the back side may have a second surface roughness, where the first and the second surface roughness are different. Preferably, the first surface roughness provides a smooth surface and the second surface roughness provides a rougher surface. A higher surface roughness of the back side of the release film provides less adhesion to the ion exchange membrane and thus a reduced risk for the electrolyte membrane to detach from support film due to adhesion between the back side of the release film and the electrolyte membrane.

For example, the front side of the monolayered release film may have a first surface roughness (arithmetical average roughness, Ra) of less than 0.10 μm and the back side of the monolayered release film may have a second surface roughness (Ra) of more than 0.05 μm. Particularly, the front side of the monolayered release film may have a first surface roughness (Ra) of less than 0.10 μm and the back side of the monolayered release film may have a second surface roughness (Ra) of equal to or more than 0.10 μm. Arithmetical average roughness, Ra, can be measured by the standard method ISO 4287:1997.

The monolayered release film may be formed by, for example, melt-extrusion. Some release films according to the present invention are commercially available, for example sPS films sold by the company Kurabo Industries Ltd, Japan, under the trademark Oidys®, such as Oidys® HNL and Oidys® HN.

The monolayered release film is preferably adjoined to (i.e. in direct contact with) the ion exchange membrane.

The ion exchange membrane laminated on the release film may be an electrolyte membrane, an electrode membrane or a membrane electrode assembly in which an electrode membrane is joined to each side of an electrolyte membrane.

In a particular embodiment, the ion exchange membrane is an electrolyte membrane, such as a polymer electrolyte membrane.

The on exchange membrane laminated on the release film may be a reinforced electrolyte membrane, such as a reinforced electrolyte membrane comprising a porous reinforcing membrane impregnated by an electrolyte. Thus, in a particular embodiment, the ion exchange membrane is a reinforced polymer electrolyte membrane

The laminate of the present disclosure can be obtained by coating a solution of a solution of an ion exchange polymer in a solvent on the monolayered release film, thereby providing a wet coating of ion exchange polymer on the monolayered release film, and thereafter removing the solvent by drying.

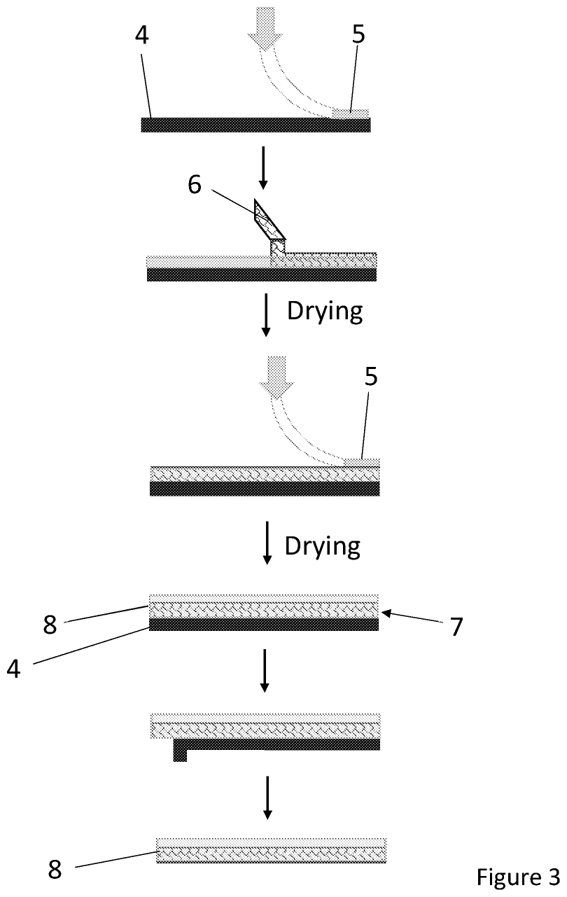

FIG. 3 illustrates a method for producing a reinforced polymer electrolyte membrane. The method comprises applying a solution of an ion exchange polymer in a solvent on a monolayered release film 4, thereby providing a wet coating 5 of ion exchange polymer on the monolayered release film 4. A reinforcing material 6, such as an ePTFE membrane, is then applied on the wet coating 5 and solvent is subsequently removed by drying. Additional solution of ion exchange polymer in a solvent may be applied in a second coating step. The solvent is removed in second drying step, thereby providing a laminate 7 of reinforced polymer electrolyte membrane (reinforced ion exchange membrane) 8 and monolayered release film 4. The monolayered release film 4 may then be removed and the reinforced polymer electrolyte membrane 8 may be used for producing a membrane electrode assembly.

The thickness of the ion exchange membrane containing the ion exchange polymer can be adjusted to the expected thickness by adjusting the concentration of the solution of the ion exchange polymer, or repeating coating and drying steps of an ion exchange polymer solution.

When the ion exchange membrane containing an ion exchange polymer is an electrolyte membrane for a polymer electrolyte fuel cell, an electrolyte solution such as a commercially available Nation® solution can be coated on the monolayered release film, followed by drying. Alternatively, a method of hot-pressing a solid polymer electrolyte membrane made separately to a release film may be used.

When the ion exchange membrane containing the ion exchange polymer is an electrode membrane for a polymer electrolyte fuel cell, a solution or dispersion containing a component of an electrode membrane (catalyst ink) can be coated on the release film, followed by drying.

When the ion exchange membrane containing the ion exchange polymer is a membrane electrode assembly for a polymer electrolyte fuel cell; as described above, an anode or cathode electrode membrane is formed on the release film, and then a polymer electrolyte membrane is joined to the electrode membrane by hot press and also the cathode or anode electrode membrane can be combined with the polymer electrolyte membrane. In the case of combining an electrode membrane with a polymer electrolyte membrane, a conventionally known method such as a screen printing method, a spray coating method or a decal method may be employed.

The ion exchange membrane is preferably a polymer electrolyte membrane for a polymer electrolyte fuel cell. Such an electrolyte membrane is not particularly limited as long as it has high proton (H⁺) conductivity and electrical insulating properties and also has air impermeability.

The polymer electrolyte membrane may have a thickness within the range of from 5 μm and 200 μm. However, since the thickness of the polymer electrolyte membrane exerts a large influence on resistance, the thickness of the polymer electrolyte membrane is generally set within a range from 5 μm to 50 μm, and preferably from 10 μm to 30 μm.

The laminate comprising an ion exchange membrane and a monolayered release film as disclosed herein may have a thickness within the range of from 15 μm to 2.00 μm, preferably from 15 μm to 100 μm (for example, 17 μm), and more preferably from 20 μm to 50 μm (for example, 22 μm), such as from 30 μm and 50 μm or from 35 μm and 50 μm (for example, 45 μm).

Suitable ion exchange polymers of the ion exchange membrane include, but are not limited to, fluorine-containing polymers including also sulfonic acid groups, carboxyl groups, phosphoric acid groups or phosphone groups. Typical examples of ion exchange polymers are perfluorinated sulfonic acid resins and perfluorinated carboxylic acid resins.

The ion exchange polymer of the polymer electrolyte membrane in the present invention is not limited to an entirely fluorine-based polymer compound. It may also be a mixture of a hydrocarbon-based polymer compound and an inorganic polymer compound, or a partially fluorine-based polymer compound containing both a C—H bond and a C—F bond in the polymer chain.

Specific examples of the hydrocarbon-based polyelectrolyte include polyamide, polyacetal, polyethylene, polypropylene, acrylic resin, polyester, polysulfone or polyether, each having an electrolyte group such as a sulfonic acid group introduced therein, and a derivative thereof; polystyrene having an electrolyte group such as a sulfonic acid group introduced therein; polyamide, polyamideimide, polyimide, polyester, polysulfone, polyetherimide, polyethersulfone or polycarbonate, each having an aromatic ring, and a derivative thereof; polyether ether ketone having an electrolyte group such as a sulfonic acid group introduced therein; and polyetherketone, polyethersulfone, polycarbonate, polyamide, polyamideimide, polyester or polyphenylene sulfide, and a derivative thereof.

Specific examples of the partially fluorine-based polyelectrolyte include a polystyrene-graft-ethylene tetrafluoroethylene copolymer or a polystyrene-graft-polytetrafluoroethylene, each having an electrolyte group such as a sulfonic acid group introduced therein, and a derivative thereof.

Specific examples of the entirely fluorine-based polymer electrolyte film include Nation® film (manufactured by DuPont), Aciplex® film (manufactured by Asahi Kasei Corporation) and Flemion® film (manufactured by Asahi Glass Co., Ltd.), each being made of perfluoropolymers having a sulfonic acid group in the side chain.

The inorganic polymer compound may be a siloxane-based or silane-based organic silicone polymer compound, and in particular an alkylsiloxane-based organic silicone polymer compound, and specific examples thereof include polydimethylsiloxane and γ-glycidoxypropyltrimethoxysilane.

The ion exchange membrane may comprise one type of ion exchange polymer or two or more ion exchange polymers. In the embodiment of two or more ion exchange polymers, the polymers can be in a mixture or as separate layers.

Solvents that are suitable for use with the ion exchange polymers include, for example, alcohols, carbonates, THF (tetrahydrofuran), water, and combinations thereof.

The laminate of the present disclosure can be obtained by
a) applying a solution of an ion exchange polymer in a solvent on the monolayered release film thereby providing a wet coating of ion exchange polymer on the monolayered release film;
b) removing the solvent by drying thereby providing the ion exchange membrane on the monolayered release film.

The ion exchange membrane may further comprise a reinforcing material, such as a porous material (e.g. ePTFE membrane), fibrous materials or reinforcing particles. In one embodiment, the reinforcing material can be porous membrane. In another embodiment, the reinforcing material may comprise fibres or particles.

The porous membrane can be defined by a morphological structure comprising a microstructure of elongated nodes interconnected by fibrils which form a structural network of voids or pores. The porous membrane (e.g. expanded polytetrafluoroethylene (ePTFE)) may be substantially impregnated with said ion exchange polymer such that the interior volume of the porous membrane becomes substantially occlusive thereby rendering the membrane essentially air impermeable. The ion exchange polymer may also be present on one or both surfaces of the porous membrane.

The porous membrane may be an expanded polytetrafluoroethylene having a porous microstructure (e.g. pores having an average size of from about 0.05 to about 0.4 μm). The expanded polytetrafluoroethylene may have a porosity (void fraction) of greater than 35%, such as within the range of from 70 to 95%.

A solution containing an ion exchange polymer in a solvent may be applied to the reinforcing material by a conventional coating technique including forward roll coating; reverse roll coating, gravure coating, or doctor roll coating, as well as dipping, brushing, painting, and spraying so long as the liquid solution is able to penetrate the interstices and interior volume of the reinforcing material. Excess solution may be removed from the surface of the reinforcing material. The treated reinforcing material is then dried in an oven. Oven temperatures may range from 60° C. to 200° C., but preferably from 160° C. to 180° C. Additional application steps, and subsequent drying, may be repeated until the reinforcing material becomes completely transparent, which corresponds to the ion exchange membrane having a Gurley number of greater than 10,000 seconds. Typically, between 2 to 60 treatments are required, but the actual number of treatments is dependent on the concentration and thickness of the reinforcing material.

In embodiments; the ion exchange membrane comprises expanded polytetrafluoroethylene impregnated with an ion exchange polymer, such as a perfluoro sulfonic acid resin.

Alternatively, the laminate of the present disclosure can be obtained by a method as illustrated in FIG. 3 comprising the steps of:
a) applying a solution of an ion exchange polymer in a solvent on the release film thereby providing a wet coating of ion exchange polymer on the release film;
b) applying a porous reinforcing material (e.g. expanded polytetrafluoroethylene) onto the wet coating of ion exchange polymer;
c) drying to remove solvent;
d) applying additional solution of ion exchange polymer in said solvent onto the porous reinforcing material; and thereafter
e) removing the solvent by drying, thereby providing the ion exchange membrane on the monolayered release film.

The electrode membrane for a polymer electrolyte fuel cell is not particularly limited as long as it contains catalyst particles and an ion exchange polymer. It is possible to use, as the ion exchange polymer, the polymer described for the above electrolyte membrane. The catalyst is usually made of a conductive material containing catalyst particles supported thereon. The catalyst particles may have a catalytic action on an oxidation reaction of hydrogen or a reductive reaction of oxygen, and it is possible to use, in addition to platinum (Pt) and other noble metals, cobalt, iron, chromium, nickel, or alloys thereof. The conductive material is suitably carbon-based particles, for example, carbon black, activated carbon and graphite, and fine powdered particles are used particularly suitably. Typical examples thereof include those obtained by supporting noble metal particles, for example, Pt particles and alloy particles made of Pt and other metals on carbon black particles having a surface area of 20 m²/g or more. Regarding a catalyst for an anode, since Pt is inferior in resistance to poisoning of carbon monoxide (CO), alloy particles made of Pt and ruthenium (Ru) are preferably used when a fuel containing CO such as methanol is used. The ion exchange polymer in the electrode membrane is a material which serves as a binder that supports a catalyst to form an electrode membrane, and forms a passage through which ions generated by the catalyst migrate. It is possible to use, as an ion exchange polymer, the materials described previously in relation to the solid polymer electrolyte membrane. The electrode membrane is preferably porous so that fuel, such as hydrogen or methanol, can be contacted with the catalyst as much as possible in an anode, whereas, an oxidizing agent gas such as oxygen or air can be contacted with the catalyst as much as possible in a cathode. It is suitable that the amount of the catalyst contained in the electrode membrane is within a range from 0.01 to 4 mg/cm² and preferably from 0.1 to 0.6 mg/cm².

### Example 1

### Production of Laminate Made of Ion Exchange Membrane on Monolayered Release Layer

The ion exchange membranes were fabricated by two times coating processes by bar coater (K202 Control coater, RK Print Coat Instrument Ltd.) and an annealing process in an oven.

Biaxially oriented expanded PTFE membrane (ePTFE) having an area density of about 3-6 g/m² was first impregnated with an ionomer solution, such as Nafion® ionomer solution (commercially available by the company DuPont, USA), provided on a releasable support film of various monolayered polymer films (see Table 1) using Mayer bar #5. The wet ePTFE and polymer film was immediately dried in an oven at 160° C. for 3 minutes (1st pass) to remove the solvents (ethanol and water).

The membranes were then impregnated again with the ionomer solution using Mayer bar #4 at room temperature and dried in the oven at the same temperature for 3 minutes (2^{nd} pass).

The membranes were finally annealed without further coating in the oven at the same temperature for 3 minutes (3^{rd} pass). The thickness of the final ion exchange membranes was about 10 μm.

### Measurement of Peel Strength

The peel strength was measured by a 90 degree peel test (ASTM D6862 except for modified sample size and peel speed) using a tensile tester (AG-I, Shimadzu Corp.). First, the ion exchange membrane on monolayered release films of various polymer films (see Table 1) was cut into 20 mm width and 150 mm length by a cut stamp. The release film side was stuck on a Bakelite board with a double-stick tape. The board was set on a tensile testing jig with rolls which automatically slides the board during peeling. The jig was attached on the base of the tensile tester. One side of the membrane was clutched by chuck of the tensile tester. The membrane was peeled off of the release film by pulling up the chuck at the speed of 15 mm/min and the peel force was recorded. The peel strength was calculated as the average value of three measurement points from 10 mm to 50 mm distance.

### Measurement of Surface Energy

The surface energy of the various polymer films as release film was determined by a two-component model including measuring contact angles with water and diiodomethane, respectively.

Each polymer film was provided on a glass plate and put into a contact angle measurement device (DM-501, Kyowa Interface Science Co., Ltd). 2.0 μL of the solvent (water or diiodomethane) was dropped from the needle of the device (tefloncoat22G). The contact angle was detected 1500 ms later from dropping with the θ/2 method (see Yang et al, “A method for correcting the contact angle from the θ/2 method”, Colloids and Surfaces A: Physiochemical and Engineering Aspects, volume 220, issues 1-3, 20 Jun. 2003, pages 199-210, DOI: 10.1016/S0927-7757(03)00064-5). The surface energy of the plastic film was determined using the Kaelble-Uy theory (D. H. Kaelble (1970) Dispersion-Polar Surface Tension Properties of Organic Solids, The Journal of Adhesion, 2:2, 66-81, DOI: 10.1080/0021846708544582).

### Results

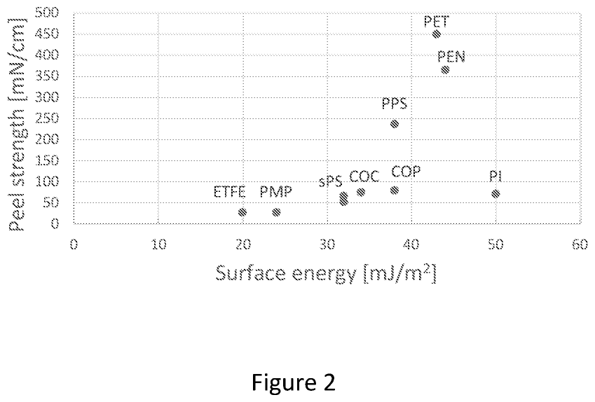

Peel strength and surface energy for the various polymer films, as measured using the herein described methods, are shown in Table 1. The peel strength versus surface energy are also shown in FIG. 2 (except for PBT and PP). The film thickness values in Table 1 have either been measured by thickness gauge or it is the thickness provided in product data sheet by the supplier.

TABLE 1

| | | Thickness of | | |
|---|---|---|---|---|
| | | monolayered | Peel | Surface |
| | Tradename | release film | strength, | energy |
| Polymer | (supplier) | [μm] | [mN/cm] | [mJ/m²] |
| PI | UPILEX (UBE) | 25 | 72 | 50 |
| PEN | Teonex (JTS) | 16 | 365 | 44 |
| PET | Lumirror (TORAY) | 50 | 450 | 43 |
| PPS | Torelina (TORAY) | 50 | 237 | 38 |
| COP | Zeonor (Zeon) | 50 | 80 | 38 |
| COC | TOPAS (Toyobo) | 50 | 75 | 34 |
| sPS | Oidys HNL (Kurabo) | 35 | 53 | 32 |
| sPS | Oidys HN (Kurabo) | 35 | 67 | 32 |
| PBT | PBT (Goyoshiko) | 40 | 1 402 | 32 |
| PP | CP (Mitsui Chemicals Tohcello) | 47 | 3 000 | 30 |
| PMP | TPX (Mitsubishi chemical) | 50 | 28 | 24 |
| ETFE | Aflex (AGC) | 51 | 28 | 20 |
| COC | (Daicel Value Coating) | 50 | 75 | 34 |
| (top layer)/ | | | | |
| PET(base layer) | | | | |

The two sPS films tested (Oidys® HNL and Oidys® HN supplied by Kurabo) were found to have the required release and adhesion characteristics to be advantageous for use as monolayered releasable support film (monolayered release film).

Also, the sPS films exhibit chemical and heat resistance as required.

Moreover, the sPS films have the required mechanical strength to be advantageous for use as releasable support film. Table 2 includes data provided by supplier (measured using method JIS K7127).

TABLE 2

| | Tensile strength [MPa] | | Tensile modulus [MPa] | | Tensile elongation [%] | |
|---|---|---|---|---|---|---|
| | Machine | Transverse | Machine | Transverse | Machine | Transverse |
| | direction | direction | direction | direction | direction | direction |
| Oidys ® | 100 | 120 | 3 400 | 3 700 | 40 | 40 |
| HNL | | | | | | |
| Oidys ® | 110 | 110 | 3 200 | 3 100 | 55 | 65 |
| HN | | | | | | |

The weight average molecular weight of the syndiotactic polystyrene of Oidys® HNL was measured according to the High temperature GPC (Gel permeation chromatography) method using the measurement device HLC-8321GPC/HT (Tosoh corporation). 20 ml o-dichlorobenzene (including 0.025% BHT) was added to 20 mg of sample (sPS film). The sample was shaken and dissolved at 145° C. The dissolution was thereafter thermally filtered by using a sintered filter (1.0 μm pore size) and the filtrate was then analysed. The syndiotactic polystyrene of Oidys® HNL was found to have a weight average molecular weight of about 177 000 g/mol.

1. A laminate comprising:
an ion exchange membrane comprising an ion exchange polymer; and
a monolayered release film removably adhered to at least one side of the ion exchange membrane, wherein the monolayered release film comprises at least 95% by weight of syndiotactic polystyrene (sPS).

2. A laminate comprising:
an ion exchange membrane comprising an ion exchange polymer; and
a monolayered release film removably adhered to at least one side of the ion exchange membrane, wherein the monolayered release film has a peel force equal to or less than 500 mN/cm using the herein described method for measurement, and a surface energy within the range of from 23 to 50 mJ/m² using the herein described method for measurement.

3. A laminate according to claim 1, wherein the monolayered release film comprises a biaxially oriented syndiotactic polystyrene film.

4. A laminate according to claim 1, wherein the monolayered release film comprises syndiotactic polystyrene selected from at least one of: expanded syndiotactic polystyrene; unsubstituted syndiotactic polystyrene.

5. A laminate according to claim 1, wherein the monolayered release film comprises syndiotactic polystyrene having a weight average molecular weight within the range of from 100 000 to 300 000 g/mol.

6. (canceled)

7. A laminate according to claim 1, wherein the monolayered release film has a tensile modulus in at least one of the machine direction and the transverse direction within the range of from 2 000 to 5 000 MPa.

8. (canceled)

9. A laminate according to claim 1, wherein the monolayered release film has a tensile strength in at least one of the machine direction and the transverse direction of at least 50 MPa.

10. (canceled)

11. A laminate according to claim 1, wherein the laminate consists of the ion exchange membrane and the monolayered release film.

12. A laminate according to claim 1, wherein the ion exchange polymer is a fluoropolymer comprising a side chain having a sulfonic acid group.

13. A laminate according to claim 1, wherein the monolayered release film has an average thickness of less than 50 μm, such as within the range of from 25 to 45 μm.

14. A laminate according to claim 1, wherein the ion exchange membrane is an electrode membrane.

15. A laminate according to claim 1, the ion exchange membrane is an electrode assembly in which an electrode membrane is joined to each side of an electrolyte membrane.

16. A laminate according to claim 1, wherein the ion exchange membrane is an electrolyte membrane.

17. A laminate according to claim 16, wherein the ion exchange membrane is a reinforced electrolyte membrane.

18. A method for producing a laminate according to claim 1, comprising a step of applying the ion exchange membrane on the monolayered release film.

19. A method according to claim 18 wherein the step of applying the ion exchange membrane is carried out by a roll-to-roll processing.

20. A method according to claim 18, wherein the step of applying the ion exchange membrane comprises:
applying a solution of the ion exchange polymer in a solvent on the monolayered release film thereby providing a wet coating of ion exchange polymer on the monolayered release film; and
removing the solvent by drying thereby providing the ion exchange membrane.

21. A method according to claim 18, comprising
applying a solution of the ion exchange polymer in a solvent on the monolayered release film thereby providing a wet coating of ion exchange polymer on the monolayered release film;
applying a porous reinforcing material, such as expanded polytetrafluorethylene, onto the wet coating of ion exchange polymer;
drying to remove solvent; applying additional solution of ion exchange polymer in said solvent onto the porous reinforcing material; and
removing the solvent by drying thereby providing the ion exchange membrane.

22. (canceled)

23. (canceled)

24. A method for producing a membrane electrode assembly of a polymer electrolyte fuel cell comprising:
providing a laminate according to claim 15; and
separating the monolayered release film from the ion exchange membrane.

25. A method for producing an electrolyte membrane comprising:
providing a laminate according to claim 16; and
separating the monolayered release film from the ion exchange membrane.
